(19) United States
(12) Patent Application Publication
(10) Pub. No.: US 2005/0278695 A1
(43) Pub. Date: Dec. 15, 2005

(54) System and method for modifying code assist within an integrated development environment

(76) Inventor: Michael J. Synovic, Lindenhurst, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/865,942

(22) Filed: Jun. 14, 2004

(51) Int. Cl. G06F 9/44

(52) U.S. Cl. 717/112

(57) ABSTRACT

A system and method for modifying code assist within an integrated development environment. The method comprises: maintaining a user editable external file and database; and modifying the user editable external file; initiating the integrated development environment; initiating a JavaScript editor plug-in; receiving a request for code assist; parsing the user editable external file; storing the parsed user editable external file in the memory storage; and displaying the parsed user editable external file in a window in the integrated development environment.

### TECHNICAL FIELD

This invention relates generally to a system and method for modifying code assist within an integrated development environment.

### BACKGROUND

Many software programmers utilize integrated development environments (“IDE”) when writing software. An IDE is an editor that allows for compiling, linking, loading, and testing of software within one user interface. The IDE relies upon the development of various plug-ins to extend its capabilities.

A plug-in is software that enriches a larger piece of software by adding features or functions. For example, a plug-in could be a program that provides online help in the form of hypertext markup language (“HTML”) based on a user's request.

With the assistance of a plug-in, an IDE is capable of dealing with many different programming languages. One particularly useful programming language is JavaScript. JavaScript is a general-purpose object language for enhancing web pages and servers. JavaScript may be embedded as a small program in a web page that is interpreted and executed by a web client. A scriptor controls the time and nature of the execution, and JavaScript functions can be called from within a web document, often executed by mouse functions, buttons, or other actions from the user. JavaScript can be used to fully control web browsers, including all the familiar browser attributes. It can also be used to build stand-alone applications that can run on either clients or servers.

JavaScript is an object-oriented programming language. Object oriented programming languages produce reusable portions of programming code known as “objects” that can be combined and re-used to create new programs. The modularity and re-usability of objects will typically speed development of new programs, thereby reducing the costs associated with the development cycle. In addition, if an error is made in defining the object, the error only needs to be fixed in the object, rather than each time an instance of the object appears. By creating and re-using a set of pre-tested, well-defined objects, a uniform approach to developing new computer programs can be achieved.

A programming language such as JavaScript contains several different default objects. In addition, JavaScript programmers often develop their own objects when writing software. Objects are comprised of methods, properties, and event handlers. In order to remember particular methods, properties and events, a JavaScript programmer will often code assist. Code assist stores default JavaScript objects and allows a programmer to obtain a listing of methods, properties and events.

The problem with code assist when used with a JavaScript editor plug-in in conjunction with an IDE is that the code assist only includes a predetermined number of default objects, methods, properties and events. A developer can modify or add methods to code assist by embedding the methods in the JavaScript code. This process, however, is inefficient and prone to errors if the developer wishes to reuse the methods in a separate piece of JavaScript code. A system that allows for a developer to add or modify methods without having to continually recreate the methods in the JavaScript code is needed.

### SUMMARY

A system for modifying code assist within an integrated development environment is presented. The system comprises a memory storage for maintaining a user editable external file and database; and a processing unit coupled to the memory storage, wherein the processing unit is operative to modify the user editable external file and the processor is further operable to: initiate the integrated development environment; initiate a JavaScript editor plug-in; receive a request for code assist; parse the user editable external file; store the parsed user editable external file in the memory storage; and display the parsed user editable external file in a window in the integrated development environment.

A method for modifying code assist within an integrated development environment is provided. The method comprises: maintaining a user editable external file and database; and modifying the user editable external file; initiating the integrated development environment; initiating a JavaScript editor plug-in; receiving a request for code assist; parsing the user editable external file; storing the parsed user editable external file in the memory storage; and displaying the parsed user editable external file in a window in the integrated development environment.

A computer-readable medium, which records a computer program for modifying code assist within an integrated development environment is provided. The computer program includes: a procedure for maintaining a user editable external file and database; and a procedure for modifying the user editable external file; a procedure for initiating the integrated development environment; a procedure for initiating a JavaScript editor plug-in; a procedure for receiving a request for code assist; a procedure for parsing the user editable external file; a procedure for storing the parsed user editable external file in the memory storage; and a procedure for displaying the parsed user editable external file in a window in the integrated development environment.

The foregoing background and summary are not intended to be comprehensive, but instead serve to help artisans of ordinary skill understand the following implementations consistent with the invention set forth in the appended claims. In addition, the foregoing background and summary are not intended to provide any independent limitations on the claimed invention.

### BRIEF DESCRIPTION OF THE DRAWINGS

The accompanying drawings show features of implementations consistent with the present invention and, together with the corresponding written description, help explain principles associated with the invention. In the drawings:

FIG. 1 is a screen shot of an exemplary embodiment of a method of modifying code assist

FIG. 2 is a functional diagram of an integrated development environment with its associated plug-ins.

FIG. 3 is a block diagram of components of a system for modifying code assist within an integrated development environment.

FIG. 4 is a flowchart of an exemplary embodiment of a method of modifying code assist.

FIG. 5 is a diagram of the method in FIG. 4.

FIG. 6 is a flowchart of an embodiment of a method of modifying code assist.

### DETAILED DESCRIPTION

The following description refers to the accompanying drawings in which, in the absence of a contrary representation, the same numbers in different drawings represent similar elements. The implementations in the following description do not represent all implementations consistent with principles of the claimed invention. Instead, they are merely some examples of methods consistent with those principles.

The ability to modify code assist provides an additional tool for software developers utilizing an IDE with a JavaScript plug-in. The tool allows a developer to modify or add existing methods, events, and properties without having to retype the methods, events, and properties in JavaScript.

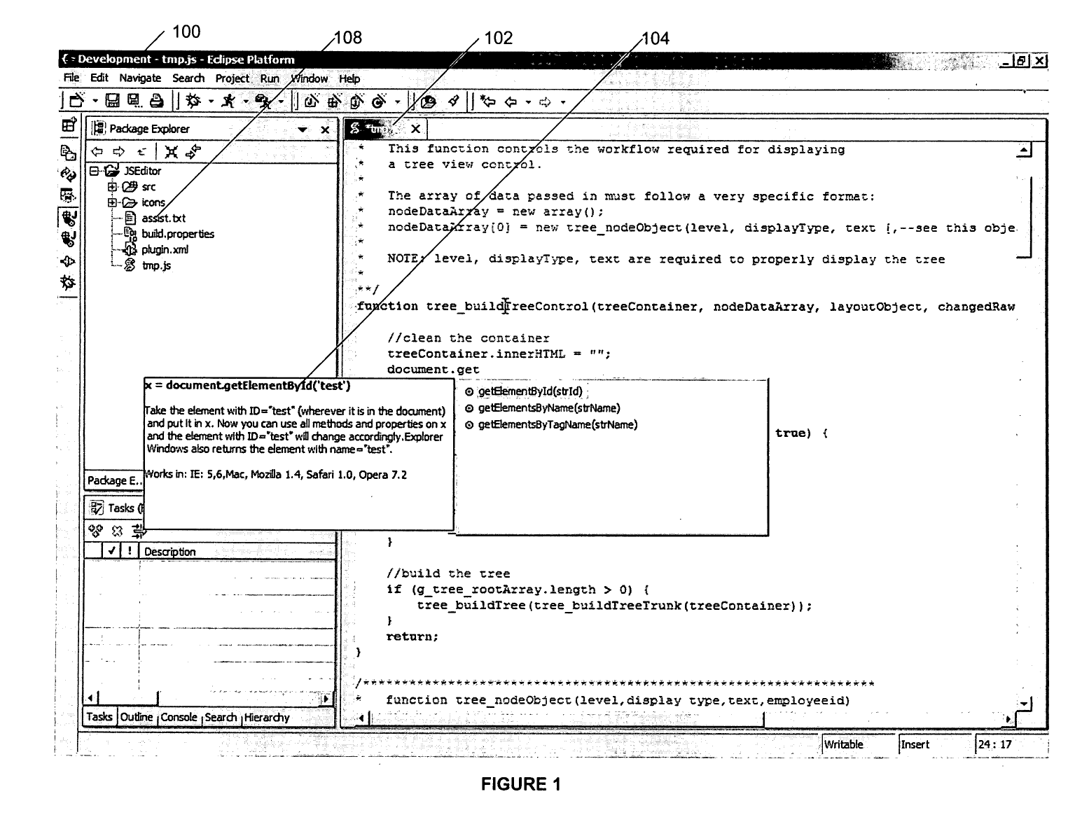

FIG. 1 is a screen shot of an integrated development environment with code assist consistent with the present invention. In FIG. 1, the IDE 100 shown is Eclipse. The Eclipse IDE 100 allows a developer to perform illustrated steps useful in developing a program within one environment. Within the Eclipse IDE 100, the JavaScript editor plug-in 102 is also active. The JavaScript editor plug-in 102 enables the Eclipse IDE 100 to manipulate JavaScript code.

In IDE 100, the developer activated code assist by pressing “.” and entered in the beginning name of the method “document.get.” The JavaScript editor plug-in 102 parsed and stored a user editable external file 108, named “assist.txt” in this example. The “assist.txt” is a user editable external file that contains methods, events and properties used by the JavaScript editor plug-in 102. Once the parsed data has been stored in memory, code assist window 104 displays the various methods that are available for “document.get”. The developer may select from the available methods and use the instructions in the code assist window 104, so that the method is used correctly.

If the method that the developer desires is not contained within the code assist window 104, then the developer may edit the external file 108 and restart the Eclipse IDE 100 and the JavaScript plug-in 102.

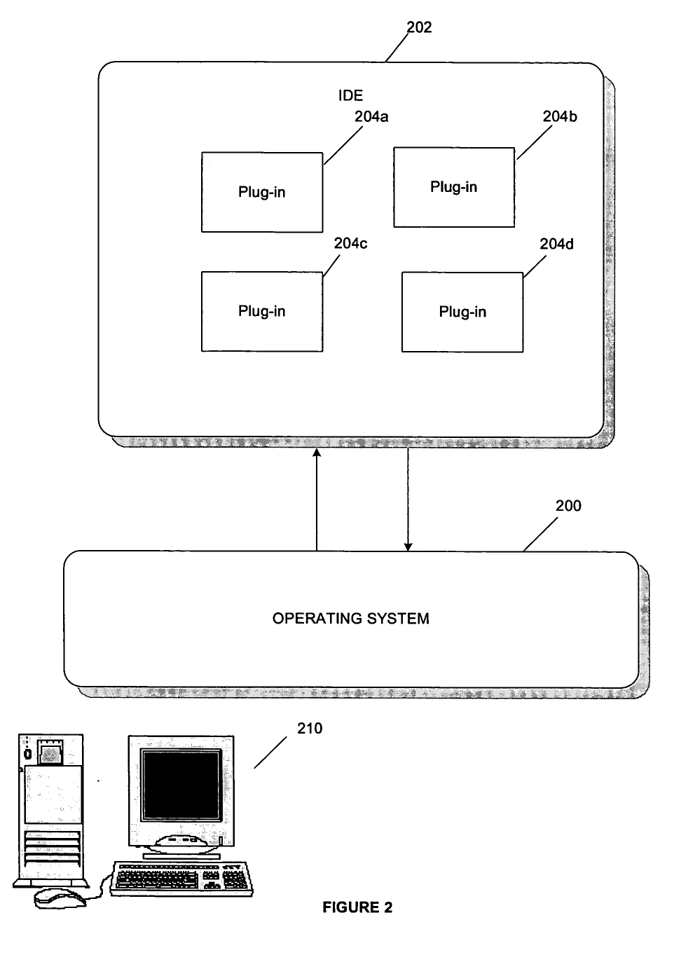

FIG. 2 is a functional diagram of an integrated development environment with its associated plug-ins. In FIG. 2, Computer 210 contains the operating system 200 and IDE 202 with its associated plug-ins 204. Computer 210 may be a general purpose computer running a computer program or a specially constructed computing platform for carrying-out the operations described below.

The IDE 202 communicates with the operating system 200 and is capable of editing, compiling, linking, loading, and testing software. An integrated development environment simplifies the development process for a software programmer by allowing the development of a program to occur all within one environment. The IDE may be implemented in conjunction with any operating system such as Windows, Unix, Linux, or Apple's OS X. An operating system is a computer program that allows multiple simultaneously executing computer programs to interact on one physical computer. The operating system conceals the details of the computer hardware from the program developer. Operating system 200 may operate with IDEs such as Eclipse, Visual Studio, Delphi or JBuilder.

IDE 202 relies upon plug-ins 204 to enhance its functionality. The plug-ins may be coded in various programming languages, such as Java, C++ or Visual Basic.

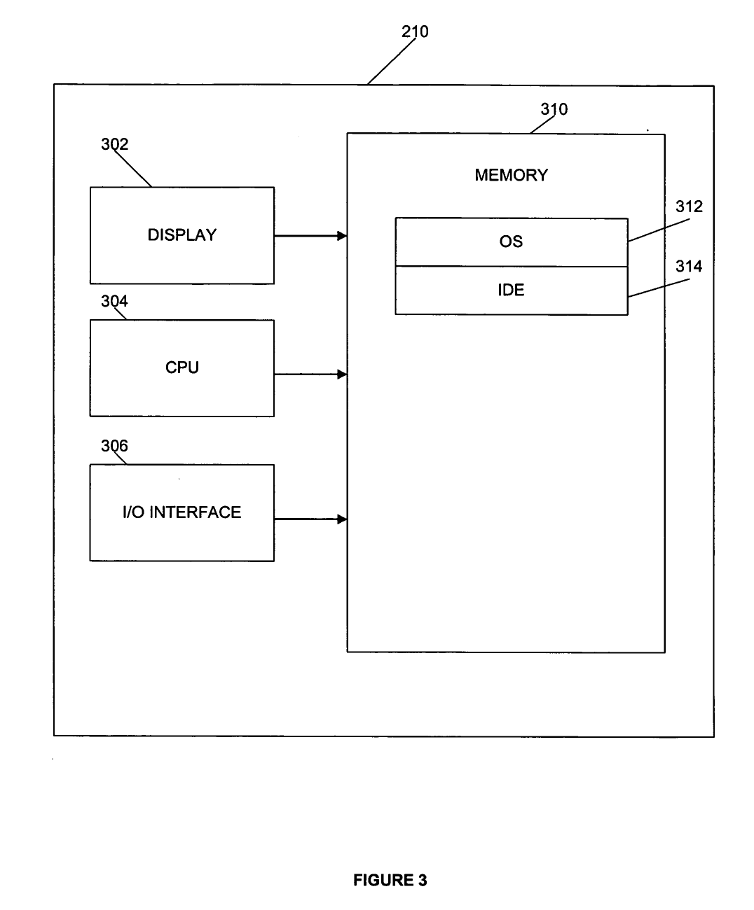

FIG. 3 is a block diagram of components of a system for modifying code assist within an integrated development environment. Computer 210, having CPU 304, may transfer data via I/O interface 306 (which can be any conventional interface) by direct connections or other communication links. Computer 210 may also provide a local or remote display 302.

Alternatively, Computer 210 can be part of a network such as a telephone-based network (such as “PBX” or “POTS”), a local area network (“LAN”), a wide are network (“WAN”), a dedicated intranet, and/or the Internet.

Memory device 310 may be implemented with various forms of memory or storage devices, such as read-only memory, random access memory, or external devices. Memory device 310 is able to store instructions forming an operating system 312 and IDE 314.

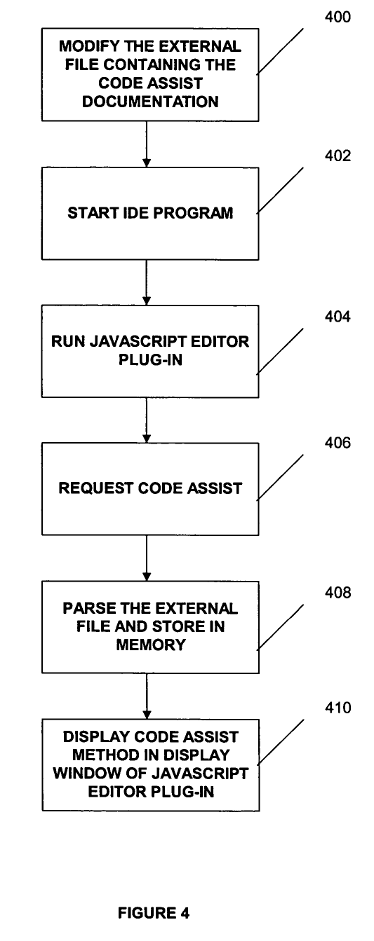

FIG. 4 is a flowchart of a method of modifying code assist consistent with the present invention. A developer modifies a user editable external file containing information, such as methods, events and properties using computer 210 (stage 400). The computer 210 may maintain the user editable external file separately from the code that provides the functionality. The user editable external file may comprise a variety of file types, such as text, HTML or extensible Markup Language (“XML”). The user editable external file may be modified by the developer to change existing methods, events and properties. The developer may also add new methods, events and properties to the user editable external file.

The IDE program is started on computer 210 (stage 402). The IDE intersects with plug-ins to edit, compile, link, load and test software.

The IDE on computer 210 initiates a JavaScript editor plug-in (stage 404). The JavaScript editor plug-in enables the IDE to manipulate JavaScript code. As mentioned earlier, JavaScript is an object-oriented programming language. Objects used in JavaScript are comprised of methods, events and properties. Therefore, there is a large amount of information that a developer needs available when coding JavaScript.

In order to access a listing of the necessary methods, events and properties, a developer uses the JavaScript editor plug-in to request code assist (stage 406). Code assist may be requested by, for example, the user pressing the “.” key on the keyboard of computer 210. Although, the “.” key is used in this example, it should be appreciated that any key or combination of keys may be used to invoke code assist.

Once the user has initiated code assist, the JavaScript editor plug-in parses the user editable external file and stores it in memory (stage 408). The code assist window appears and displays a listing of one or more of the available methods, properties and events (stage 410). For example, the developer may narrow the list of displayed available methods by entering the beginning letter of a method. The code assist will then display methods that begin with that letter.

If the method that the developer is looking for does not exist within the methods displayed, the developer may edit the external file (stage 400) and repeat the process, or she may manually enter the method into the IDE.

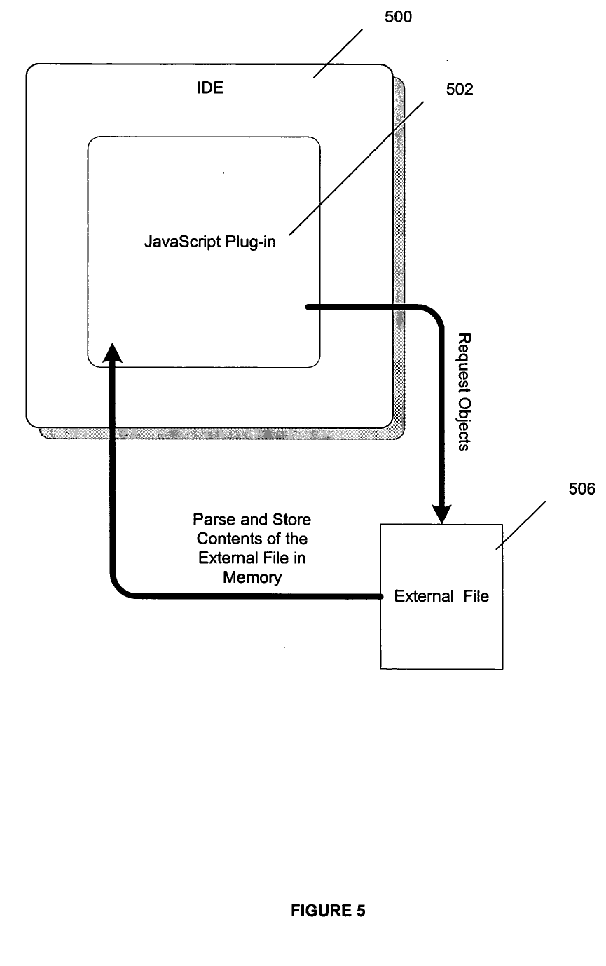

FIG. 5 is a diagram of the method in FIG. 4. In FIG. 5, IDE 500 contains JavaScript editor plug-in 502. JavaScript plug-in 502 requests methods from a user editable external file 506. JavaScript editor plug-in 502 parses and stores the contents of user editable external file 506 in memory. The contents of the parsed user editable external file are then displayed in the code assist window when the user involves code assist.

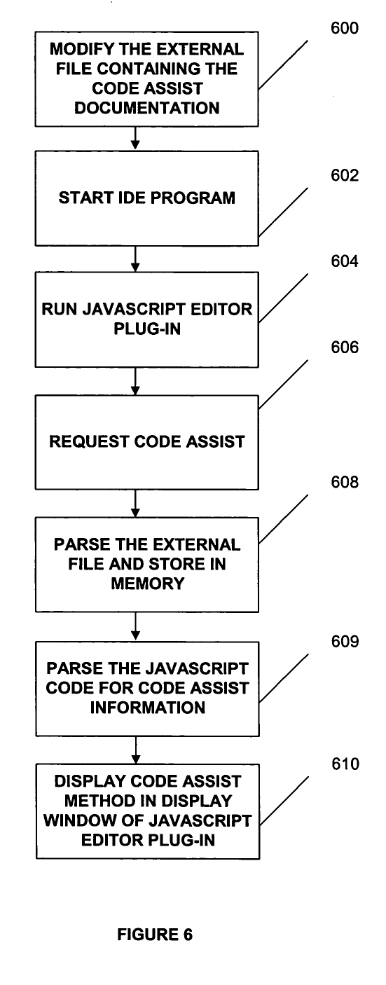

FIG. 6 is a flowchart of a method of modifying code assist. A developer modifies a user editable external file containing methods, events, and properties (stage 600). The user editable external file may be maintained separately from the code that is needed to provide the functionality. The user editable external file may comprise a variety of file types, such as text, HTML or XML. The user editable external file may be modified by the developer to change existing methods, events or properties. The developer may also create new objects, methods, events or properties.

The IDE program is started on computer 210 (stage 602). The IDE interacts with plug-ins to edit, compile, link, load and test software.

The IDE on computer 210 initiates a JavaScript editor plug-in (stage 604). The JavaScript editor plug-in enables the IDE to manipulate JavaScript code. When the JavaScript editor plug-in is initiated, the developer is able to write JavaScript code. As mentioned earlier, JavaScript is an object-oriented program. Objects used in JavaScript are comprised of methods, events, and properties.

In order to access a listing of the necessary methods, events and properties, a developer uses the JavaScript editor plug-in to request code assist (stage 606). Code assist may be requested, for example, by the user pressing the “.” key on the keyboard of computer 210. Although, the “.” key is used in this example, it should be appreciated that any key or combination of keys may be used to invoke code assist.

Once the user has invoked code assist the JavaScript editor plug-in parses the user editable external file and stores it in memory (stage 608). The JavaScript editor plug-in is parsed for any new methods, events or properties that were created by the developer in the JavaScript code (stage 609). As discussed earlier, a developer is able to embed new methods, events or properties in the JavaScript code. The code assist window appears and displays a listing of the available methods, properties, and events (stage 610). For example, the developer may narrow the list of displayed available methods by entering the beginning letter of a method. The code assist will then display methods that begin with that letter.

If the method that the developer is looking for does not exist within the methods displayed, the developer may edit the external file (stage 600) and repeat the process, or she may manually enter the method into the IDE.

The foregoing description of possible implementations consistent with the present invention does not represent a comprehensive list of all such implementations or all variations of the implementations described. The description of only some implementation should not be construed as an intention to exclude other implementations. Artisans will understand how to implement the invention in the appended claims in many other ways, using equivalents and alternatives that do not depart from the scope of the following claims. Moreover, unless indicated to the contrary in the preceding description, none of the components described in the implementations is essential to the invention.

1. A system for modifying code assist within an integrated development environment, the system comprising:
a memory storage for maintaining a user editable external file and database; and
a processing unit coupled to the memory storage, wherein the processing unit is operative to modify the user editable external file and the processor is further operable to:
initiate the integrated development environment;
initiate a JavaScript editor plug-in;
receive a request for code assist;
parse the user editable external file;
store the parsed user editable external file in the memory storage; and
display the parsed user editable external file in a window in the integrated development environment.

2. The system for modifying code assist according to claim 1, wherein JavaScript code is parsed for methods, events and properties; and
the parsed methods, events and properties of the JavaScript code are displayed utilizing code assist in the JavaScript editor plug-in.

3. The system for modifying code assist according to claim 1, wherein the integrated development environment is Eclipse.

4. The system for modifying code assist according to claim 1, wherein the user editable external file is a text file.

5. The system for modifying code assist according to claim 1, wherein the user editable external file is a XML file.

6. A method for modifying code assist within an integrated development environment comprising:
maintaining a user editable external file and database; and
modifying the user editable external file;
initiating the integrated development environment;
initiating a JavaScript editor plug-in;
receiving a request for code assist;
parsing the user editable external file;
storing the parsed user editable external file in the memory storage; and
displaying the parsed user editable external file in a window in the integrated development environment.

7. The method for modifying code assist according to claim 6, wherein JavaScript code is parsed for methods, events and properties; and
the parsed methods, events and properties of the JavaScript code are displayed utilizing code assist in the JavaScript editor plug-in.

8. The method for modifying code assist according to claim 6, wherein the integrated development environment is Eclipse.

9. The method for modifying code assist according to claim 6, wherein the user editable external file is a text file.

10. The method for modifying code assist according to claim 6, wherein the user editable external file is a XML file.

11. A computer-readable medium which records a computer program, wherein the computer program includes:
a procedure for maintaining a user editable external file and database; and
a procedure for modifying the user editable external file;
a procedure for initiating the integrated development environment;
a procedure for initiating a JavaScript editor plug-in;
a procedure for receiving a request for code assist;
a procedure for parsing the user editable external file;
a procedure for storing the parsed user editable external file in the memory storage; and
a procedure for displaying the parsed user editable external file in a window in the integrated development environment.

12. The computer-readable recording medium which records a computer program according to claim 11, wherein JavaScript code is parsed for methods, events and properties; and
the parsed methods, events and properties of the JavaScript code are displayed utilizing code assist in the JavaScript editor plug-in.

13. The computer-readable recording medium which records a computer program according to claim 11, wherein the integrated development environment is Eclipse.

14. The computer-readable recording medium which records a computer program according to claim 11, wherein the user editable external file is a text file.

15. The computer-readable recording medium which records a computer program according to claim 11, wherein the user editable external file is a XML file.
